(19) United States
(12) Patent Application Publication
(10) Pub. No.: US 2019/0213803 A1
(43) Pub. Date: Jul. 11, 2019

(54) CLOUD-BASED REAL-TIME PREDICTIVE MAINTENANCE FOR VEHICLE COMPONENTS

(71) Applicant: Byton Limited, Hong Kong (HK)

(72) Inventors: Haizhong Ye, San Francisco, CA (US); Peng Chen, San Jose, CA (US)

(21) Appl. No.: 15/863,842

(22) Filed: Jan. 5, 2018

(51) Int. Cl. G07C 5/00; G07C 5/08; H04L 29/06

(52) U.S. Cl. CPC G07C 5/006; G07C 5/0808; H04L 67/38; G07C 5/085; G07C 5/008

(57) ABSTRACT

A disclosed embodiment includes a direct sensor, a proxy sensor, or both, coupled to a vehicle component. A controller is communicatively coupled to the direct sensor and/or the proxy sensor. A user interface and a transceiver are communicatively coupled to the controller. The controller can sample a measurement of a lifetime determinant from the direct sensor, a measurement of a proxy lifetime determinant from the proxy sensor, or both, at a sampling frequency; timestamp each sample of the lifetime determinant and the proxy lifetime determinant; at the end of a reporting period, assemble a dataset including a vehicle identifier, a component identifier, the samples of at least one of the lifetime determinant or the proxy lifetime determinant, and the timestamp associated with each sample of the lifetime determinant or the proxy lifetime determinant; and transmit the dataset to a cloud computing center via the transceiver and the antenna.

### TECHNICAL FIELD

The disclosed embodiments relate generally to preventative maintenance for vehicle components and in particular, but not exclusively, to cloud-based real-time predictive maintenance for vehicle components.

### BACKGROUND

Most vehicles include numerous components, with lifetimes shorter than the vehicle's, meaning that these components will need to be repaired or replaced at least once during the vehicle's lifetime. For components that affect the performance, reliability, or safety of the vehicle, it is especially important to repair or replace them before they reach the end of their lifetime—that is, before they fail and cause an inconvenience or an accident, with all the economic consequences they entail.

To avoid component failures and improve reliability vehicles are currently maintained mostly based on fixed mileage intervals or fixed time intervals set by the vehicle manufacturer. But the varied usage of each vehicle by its driver means that the mileage or time intervals might be inappropriate—too long for some, too short for others. Drivers for whom the fixed intervals are too short end up spending more than needed on maintenance, while drivers for whom the fixed intervals are too long can experience component failures that can create damage beyond the component itself—if the component failure causes an accident, for instance—and also result in greater maintenance cost than needed.

### SUMMARY

Embodiments of an apparatus for use in a vehicle to provide cloud-based real-time predictive maintenance for vehicle components are described. The apparatus includes a direct sensor, a proxy sensor, or both, coupled to a component in a vehicle. A controller is communicatively coupled to the direct sensor and/or the proxy sensor. A user inter-face and a transceiver are communicatively coupled to the controller. The controller includes instructions stored thereon that when executed cause the controller to sample a measurement of a lifetime determinant from the direct sensor, a measurement of a proxy lifetime determinant from the proxy sensor, or both, at a sampling frequency; timestamp each sample of the lifetime determinant and the proxy lifetime determinant; at the end of a reporting period, assemble a dataset including a vehicle identifier, a component identifier, the samples of at least one of the lifetime determinant or the proxy lifetime determinant, and the timestamp associated with each sample of the lifetime determinant or the proxy lifetime determinant; and transmit the dataset to a cloud computing center via the transceiver and the antenna.

Embodiments of an apparatus for cloud-based computing to provide cloud-based real-time predictive maintenance for vehicle components are described. The apparatus includes a communication interface, one or more databases, and a server coupled to the communication interface and to the one or more databases. The server can receive a dataset through the communication interface, the dataset including a vehicle identifier, a component identifier, samples of at least one of the lifetime determinant or the proxy lifetime determinant, and a timestamp associated with each sample of the lifetime determinant or the proxy lifetime determinant. The server can access the one or more databases to add the data from the received dataset to a stored time history of the lifetime determinant or the proxy lifetime determinant for the component identified in the received dataset and the vehicle associated with the vehicle identifier, extract lifetime data for the component identified in the received dataset and, based on the lifetime data, at least one of the lifetime determinant or the proxy lifetime determinant, and the time history of the lifetime determinant or the proxy lifetime determinant, compute a state-of-health that quantifies the remaining lifetime of the component. If the state-of-health of the component falls within an imminence threshold, transmit a warning to the operator of the vehicle associated with the vehicle identifier.

Embodiments of a method for use in a vehicle to provide cloud-based real-time predictive maintenance for vehicle components are described. The method includes sampling, at a sampling frequency, a measurement of a lifetime determinant from a direct sensor, a measurement of a proxy lifetime determinant from a proxy sensor, or both, wherein the direct sensor and the proxy sensor are coupled to a component in a vehicle. Each sample of the lifetime determinant or the proxy lifetime determinant is timestamped. At the end of a reporting period, a dataset is assembled including a vehicle identifier, a component identifier, the samples of at least one of the lifetime determinant or the proxy lifetime determinant, and the timestamp associated with each sample of the lifetime determinant or the proxy lifetime determinant. The dataset is transmitted to a cloud computing center.

Embodiments of a method for cloud-based computing to provide cloud-based real-time predictive maintenance for vehicle components are described. The method includes receiving a dataset from a vehicle, the vehicle including one or both of a direct sensor or a proxy sensor coupled to a component, the dataset including a vehicle identifier, a component identifier, samples of at least one of the lifetime determinant or the proxy lifetime determinant, and a timestamp associated with each sample of the lifetime determinant or the proxy lifetime determinant. One or more databases are accessed to add the data from the received dataset to a stored time history of the lifetime determinant or the proxy lifetime determinant for the component identified in the received dataset and the vehicle associated with the vehicle identifier, extract lifetime data for the component identified in the received dataset, and based on the lifetime data, at least one of the lifetime determinant or the proxy lifetime determinant, and a time history of the lifetime determinant or the proxy lifetime determinant, compute a state-of-health that quantifies the remaining lifetime of the component. A warning can be transmitted to the operator of the vehicle associated with the vehicle identifier if the state-of-health of the component falls within an imminence threshold.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of an embodiment of a system for cloud-based real-time predictive maintenance for vehicle components.

FIG. 2 is a flowchart of an embodiment of a process used by the vehicle in FIG. 1.

FIG. 3 is a flowchart of an embodiment of a process used by the cloud computing center in FIG. 1.

FIG. 4 is a block diagram of a vehicle including an embodiment of an onboard reporting system.

### DETAILED DESCRIPTION

Embodiments of an apparatus and method for cloud-based real-time predictive maintenance for vehicle components are described below. One part of the apparatus is in a vehicle, another is in a cloud-computing center. In the vehicle part of the apparatus, one or more components in the vehicle are monitored with sensors that directly sense a lifetime determinant of the component (i.e., a quantity such as temperature whose history primarily determines a lifetime of the component) or a proxy lifetime determinant (i.e., a quantity from which a lifetime determinant can be deduced). The sensors are sampled by the electronic control unit (ECU) of the component at a certain sampling frequency and over a reporting period. Then, the sensor data is sent to the vehicle control unit (VCU). The VCU assembles a dataset that includes a vehicle identifier, a component identifier, the samples of the lifetime determinant or the proxy lifetime determinant, and the timestamp associated with each sample. Using a transceiver coupled to the VCU, the dataset is transmitted to a cloud-computing center for processing and a new reporting period begins. Simultaneously with gathering and sending data, the VCU listens for a warning from the cloud-computing center. The warning will come if, based on data from the sensors, the cloud-computing center determines that any of the components is near the end of its lifetime.

The cloud computing center includes a communication interface through which it can communicate with the vehicle, one or more servers coupled to the communication interface, and one or more databases coupled to the servers. The cloud-computing center received the datasets from the vehicle and compiles a database with the history (i.e., the variation over time) of the lifetime determinant or the proxy lifetime determinant for each component being monitored in that vehicle. Using the history of the lifetime determinant or the proxy lifetime determinant for the particular component in the particular vehicle, together with data stored in the databases for that particular component—for instance, experimentally determined lifetime data or lifetime data determined from collecting histories for that component from a fleet of vehicles—the cloud-computing center computes a state of health (SOH) for the component. If the SOH indicates that the component is near the end of its lifetime, then the cloud-computing center can send a warning to the driver of the vehicle informing them that the component must be replaced very soon. The cloud-computing center can also notify a repair facility or service center so that a replacement component can be ordered before the vehicle is brought in.

Among other things, objects of the disclosed embodiments include encouraging adoption and use of electric vehicles by improving their performance, safety, and reliability; encouraging adoption and use of electric vehicles by reducing their repair costs; reducing environmental impacts from prematurely discarding vehicle components; and reducing the social costs of accidents and incidents caused by operating vehicles past the lifetime of key components.

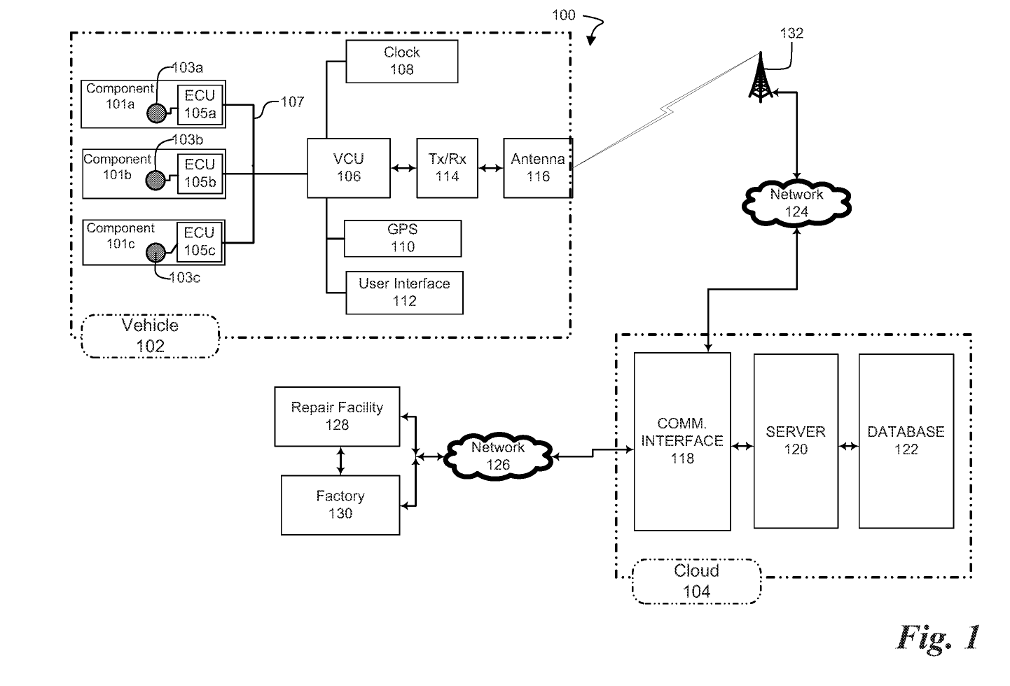

FIG. 1 illustrates an embodiment of a system 100 for real-time predictive maintenance for vehicle components. System 100 implements a cloud-based state of health (SOH) estimation method for components such as power semiconductor modules used in traction inverters on electric vehicles so that the electric vehicles can notify drivers of impending component failure and provide predictive maintenance capability. In addition, a vehicle service center or repair facility can receive corresponding component order so that they can prepare in advance to replace or repair the component. Although the embodiments below are mostly described as being used in a fully electric vehicle, other embodiments of system 100 can also be used in partially electric (i.e., hybrid) vehicles and non-electric vehicles, such as vehicles with a traditional internal combustion engine. And although described mostly in the context of automobiles, the illustrated systems and methods can also be used in other wheeled vehicles such as trucks, motorcycles, buses, trains, etc. It can also be used in non-wheeled vehicles such as ships, airplanes (powered or gliders), and rockets. In fact, the illustrated embodiments can be used in any situation in which it is useful to monitor the state of health of a component and notify of its imminent end of life. For instance, the illustrated system can be used in situations unrelated to transportation, such as homes, offices, space stations, etc.

System 100 includes a vehicle 102 communicatively coupled a cloud computing center 104. Cloud computing center 104 is in turn communicatively coupled to a repair facility 128 and a supplier factory 130. In the context of this application, “communicatively coupled” means coupled in such a way that data can be exchanged, in one or both directions, between two entities or components. Although only one vehicle 102 is shown, in other embodiments there need not be a one-to-one correspondence between vehicles and cloud computing center. In other embodiments, for instance, cloud computing center 104—which can, for instance, be set up and run by a vehicle manufacturer—can be communicatively coupled to multiple vehicles from that manufacturer, up to and including the entire fleet of that manufacturer's vehicles. And although only one repair facility 128 and one factory 130 are shown, in other embodiments cloud computing center 104 can be communicatively coupled to multiple repair facilities and multiple factories.

Vehicle 102 includes one or more components 101, each having an electronic control unit (ECU) 105 coupled a corresponding sensor 103, and each ECU 105 is communicatively coupled, via a controller area network (CAN) bus 107, to a vehicle control unit (VCU) 106. VCU 106 is in turn communicatively coupled to a clock 108, a GPS unit 110, a user interface 112, and a transceiver 114. Although shown in the figure as a separate component from VCU 106, in some embodiments clock 108 can be a real-time application-specific integrated circuit (ASIC) clock within VCU 106. Transceiver 114 is communicatively coupled to an antenna 116, through which vehicle 102 can wirelessly transmit data to, and receive data from, cloud computing center 104. In the illustrated embodiment, vehicle 102 communicates wirelessly via antenna 116 with a tower 132, which can then communicate via network 124 with cloud computing center 104.

Components 101 are generally components whose lifetime is important to the performance, reliability, or safety of vehicle 102, so that it is highly beneficial to be able to predict when components 101 are at or near failure—in other words, when they are at or near the end of their lifetimes. In the illustrated embodiment there are three components 101a-101c, but other embodiments can have more or less components 101 than shown. Components 101 can, for instance, be components that are important for performance, reliability, and safety and have a low mean time between failures (MTBF). For example, in battery-powered electric vehicles power electronic systems such as traction inverters plays an important role in delivering electric power to the electric motors that make up the vehicle's powertrain. High reliability of these power electronic systems is desirable for electric vehicles because they are safety critical. Industry-based surveys of reliability of power electronic show the reliability of power electronic converters (e.g., traction inverters) is an important issue, and power semiconductors are some of the most vulnerable components. Semiconductor and soldering failures in power semiconductor modules total 34% of power electronic converter failures, according to a survey based on over 200 products from 80 companies.

Each component 101 has a lifetime determinant—that is, a quantity whose history (i.e., variation over time) has been determined, through analysis, observation, experiment, etc., to most affect the component's lifetime. The lifetime determinant can be used to predict the component's failure—i.e., the end of its lifetime. For instance, in the traction inverter used in battery-powered electric vehicles, the junction temperature of power semiconductors is a lifetime determinant because, given the inverter's failure mechanisms, the junction temperature history can be used to predict its lifetime. High thermal stress is introduced in the power semiconductor modules of traction inverters because of the temperature swings and different coefficients of thermal expansion of different material layers in the modules. Possible failure mechanisms include solder cracking and wire lift-off. Failure of traction inverters can cause accidents if they fail when the vehicles are operating.

A sensor 103 is coupled to each component 101: sensor 103a is coupled to component 101a, sensor 103b is coupled to component 101b, and so on. Although illustrated in the drawing as a single unit, each sensor 103a-103c can include multiple sensors, so that there need not be a one-to-one correspondence between sensors and components. Sensors 103 can include one or both of direct sensors that directly measure a lifetime determinant of the corresponding component and proxy sensors that instead measure a proxy lifetime determinant from which the lifetime determinant can be deduced by analysis, observation, or experiment. In the traction inverter discussed above, sensor 103 can be a direct sensor that measures the junction temperature of power semiconductors. But if the manufacturer does not build a temperature sensor into the power semiconductors there is no direct measured temperature. However, the junction temperature can be estimated by using the coolant temperature and an electrothermal model. In such an embodiment sensor 103 can be a proxy sensor that measures the coolant temperature of the traction inverter instead of the temperature of the power semiconductor itself.

The junction temperature of the power semiconductor module can be estimated or measured depending on the module suppliers. If power semiconductor modules do not have temperature sensors on silicon dies, a junction temperature estimation algorithm can be used to estimate the junction temperatures. If the power semiconductors have the thermal diode in the silicon die, then the temperature can be measured directly.

Vehicle control unit (VCU) 106 is a controller including a microprocessor, memory, storage, and a communication interface with which it can communicate with other components such as sensors 103a-103c, clock 108, global positioning system (GPS) 110, user interface 112, and transceiver 114. In one embodiment VCU 106 is the vehicle's main computer, but in other embodiments it can be a component separate from the vehicle's main or primary computer.

Cloud computing center 104 includes a communication interface 118, a server 120 and one or more databases 122. Communication interface 118 is communicatively coupled to server 120 and to networks 124 and 126, so that cloud computing center 104 can exchange data with vehicle 102 through network 124 and can also send information to repair facility 128 and/or factory 130 via network 126. Although illustrated as a single server, in other embodiments server 120 can include multiple servers, each of which includes one or more microprocessors, memory, and storage.

The computational complexity and massive data storage associated with the lifetime estimation of vehicle components such as power semiconductor modules is better implemented using cloud computing instead of the vehicle's own VCU or other onboard computational resources. Precious onboard computational resources, executive time of the microcontroller, and cost, can be saved. And because lifetime determinant profile data for each vehicle can be gathered in the cloud, the statistical information of the profiles can be given to the component supplier for further analysis and diagnosis, thus helping the component supplier improve the reliability or refine their products to meet the customers' requirement.

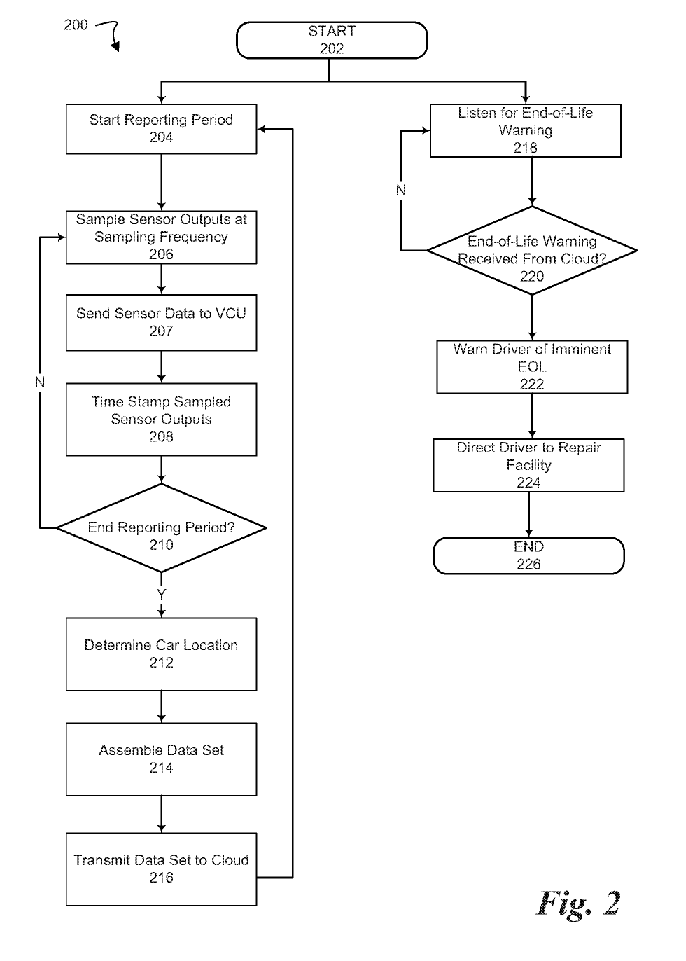

FIG. 2 illustrates an embodiment of a process 200 used by a vehicle. Process 200 is discussed in the context of system 100, but can also be used in other embodiments of system 100. In system 100, process 200 is executed primarily by vehicle control unit (VCU) 106, but in other embodiments can be executed by a different component onboard the vehicle. The process starts at block 202 and includes two branches that are executed simultaneously or substantially simultaneously: a reporting branch including blocks 204-216 that reports vehicle data to a cloud computing center, and a warning branch including blocks 218-226 that provides warnings received from the cloud computing center as needed, depending on the cloud data center's analysis of the vehicle data collected and reported in blocks 204-216.

The reporting branch of the process begins at block 204, where a reporting period—a period during which the process collects sensor outputs for reporting to the cloud computing center—begins. At block 206 ECUs 105a-105c sample outputs from sensors 103a-103c at a sampling frequency. The reporting period and sampling frequency can be chosen so that processes 200 and 300 occur in real time or substantially real time. For instance, in one embodiment the reporting period and the sampling period (i.e., the reciprocal of the sampling frequency) can be equal, so that every sample is immediately transmitted to the cloud computing center. In other embodiments the reporting period can be longer than the sampling period, so that multiple samples are aggregated before being sent to the cloud computing center.

At block 207, the sampled sensor data is sent to VCU 106, and at block 208 each sampled sensor output is timestamped, for instance using the output of clock 108. At block 210 the process checks whether the reporting period has ended. If the reporting period has not ended the process returns to block 206, where it continues to sample outputs of sensors 103 at the sampling frequency. But if at block 210 the reporting period has ended, the process moves on to block 212, where it optionally determines the vehicle's current location, for instance using GPS 110, so that the vehicle's current location can also be reported to the cloud computing center.

A block 214 the process assembles a dataset for transmission to cloud computing center 104. In one embodiment, the dataset can include a vehicle identifier, a component identifier for each component 101 with a sensor 103 whose output is being sampled, the sampled output from each sensor, and the timestamp associated with each sample from each sensor. In other embodiments the dataset can include additional information, such as the vehicle's current location. At block 216 the dataset assembled at block 214 is transmitted, via transceiver 114 and antenna 116, to cloud computing center 104 for analysis. Having transmitted the dataset to the cloud computing center the process returns to block 204, where a new reporting period starts and the process then proceeds again through blocks 204-216.

The warning branch of process 200 begins at block 218, where the process listens for an end-of-life (EOL) warning from the cloud computing center. If, based on data sent to the cloud computing center at block 216, cloud computing center 104 determines that any of components 101a-101c is within a certain imminence threshold of the end of its lifetime, then the cloud computing center will send a warning to the vehicle, which process 200 listens for at block 218.

At block 220 the process checks whether an EOL warning has been received from cloud computing center 104. If at block 220 no end-of-life warning has been received, the process returns to block 218 and continues listening. But if at block 220 an EOL warning is received the process moves on to block 222, where it warns the vehicle's driver of the imminent failure of one or more of the components being monitored by displaying a warning on user interface 112. The EOL warning can include the value of the component's SOH (see below), the estimated time or range remaining for the component, and the location of a preferred or registered repair facility, the locations of multiple nearby repair facilities from which the driver can choose, and other relevant information.

Having received an EOL warning at block 222, at block 224 the process can use GPS 110 to direct the vehicle's driver to a repair facility that can replace or repair the component whose failure is imminent. In various embodiments, the repair facility identified in the EOL warning at block 220 can be a home repair facility or a preferred repair facility previously registered for the vehicle in database 122, or can be one or more repair facilities near the vehicle's current location. In the context of process 200, a repair facility can be considered near the vehicle's current location if it is within a certain mileage range (e.g., 0-100 miles), within a certain travel time (e.g., 0-2 hours), or within the time or range available to the vehicle before failure of the component associated with the EOL warning. The warning branch of process 200 ends at block 226.

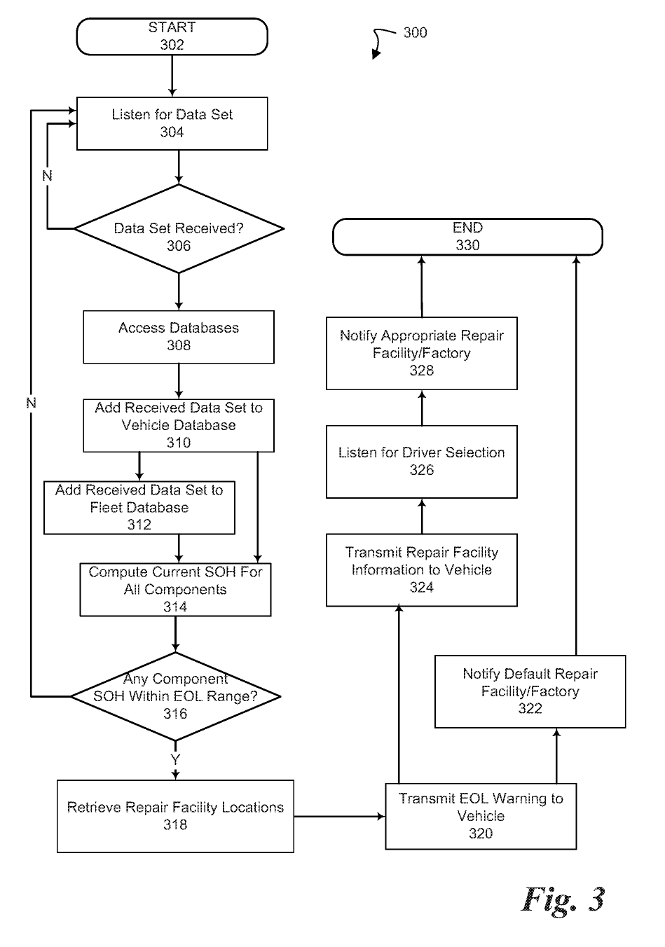

FIG. 3 illustrates an embodiment of a process 300 used by a cloud computing center to predict a component's lifetime. Process 300 is discussed below in the context of system 100, but can also be used in other embodiments of system 100. In system 100 process 300 is executed primarily by server 120. The process starts at block 302.

At block 304, the process listens for receipt of a dataset from vehicle 102. If at block 306 no dataset has been received, the process returns to block 304 where it continues to listen for receipt of a dataset. But if at block 306 the process notes that a dataset has been received, then at block 308 it accesses database 122 in which it keeps vehicle data, and at block 310 it adds the data from the received dataset to the database, in particular adding it to existing data for the vehicle identified in the dataset so as to compile a historical record for the vehicle.

From block 310 the process moves to block 314, either directly or via block 312. At block 312, in addition to adding data from the received dataset to the existing data for the vehicle identified in the dataset, at block 312 the process can add the received data to a fleet database, for instance a database covering multiple vehicles and/or multiple models from a particular vehicle manufacturer. The fleet database can then be used to extract lifetime information about components found in the manufacturer's vehicles, so that the fleet data can be used to compute the state-of-health of components.

At block 314, based on the historical data for the identified vehicle and the most recently received data from the identified vehicle, the process computes a state of health (SOH) metric for each component for which data was received. In an embodiment in which the components are power semiconductor devices of a traction inverter, SOH can be defined as:

$$SOH = 1 - {\sum }_{i = 1}^{n} \frac{{N}_{i}}{{N}_{fi}}$$

where N_{fi} is the lifetime number of cycles measured at the temperature fluctuation of ΔTᵢ, Nᵢ is the cumulative number of cycles at the temperature fluctuation of ΔTᵢ, and N_{fi} is representative of the number of cycles that defined the lifetime of the component. Values for N_{fi} can be obtained from various sources. In one embodiment, N_{fi} can be obtained from data provided by the component manufacturer, for instance based on experiments in which the lifetime cycles at different ΔT are obtained first by using the accelerated power cycling and temperature cycling tests. Then, the temperature cycles of power modules can be obtained by using predefined mission profiles such as drive cycles. Generally, the rainflow cycle counting is one of the most common cycle-counting techniques, is used in fatigue analysis. Finally, Miner's rule, which assumes that the damage accumulates linearly, is commonly applied to calculate the accumulated fatigue damage. The device fails when the damage accumulates to 1. Another method provides a very complex formulation to transfer the simulated temperature swings to the number of cycles under the test conditions. Different power semiconductor suppliers may have different formulas for the conversion due to different manufacturing processes. These experimental methods have two drawbacks to predict the lifetime of components such as power semiconductor in real applications: 1) The predefined mission profiles differ from the real profiles due to the varied usage of vehicle and its unique mission profile; 2) The method cannot predict when the power modules need to be replaced.

In another embodiment, N_{fi} can be determined from fleet data stored in a fleet database, in which case N_{fi} would be based on actual fleet experience rather than experimental results. If a lifetime estimation model is applied, the SOH is defined as the remaining lifetime number of cycles over the total lifetime number of cycles. In the above formulation of SOH, a component has an SOH of 1 when it is brand new (i.e., it has undergone no temperature cycles) and 0 when it has reached the end of its lifetime.

At block 316 process 300 checks whether any component for which data has been received has an SOH that indicates that the component is near the end of its lifetime. A component can be near the end of its lifetime if its SOH is within a set imminence range (i.e., a range of SOH that indicates failure is imminent). For instance, in an embodiment where SOH is computed as above and has a value range between 0 and 1, an imminence range that triggers and EOL warning can be when SOH 0.05. In an embodiment with multiple components 101, not every component need have the same imminence threshold. If at block 316 the process determines that no component has a SOH within its imminence range, then the process returns to block 304 and listens for new datasets from the vehicle. But if at block 316 the process determines that any component has an SOH within its imminence range, then it proceeds to block 318 where it determines or retrieves repair facility locations.

At block 320, the process transmits an EOL warning to vehicle 102. The EOL warning can include the locations and identities of one or more repair facilities. At block 322 the process can notify an appropriate repair facility, after which the process ends at block 330. For instance, if cloud computing facility 104 is run by a vehicle manufacturer, the vehicle's owner might have previously registered a home address for the vehicle, a preferred repair facility, or both. If the vehicle's owner as indicated a home or preferred repair facility, then that facility can be notified. Otherwise, the repair facility closest to the vehicle's home address can be notified.

Alternatively, at block 324 repair facility information for multiple repair facilities can be transmitted to the vehicle based on the vehicle's current location. For instance, the locations of several nearby repair facilities can be transmitted to the vehicle and displayed on user interface 112 so that the driver can select which repair facility they prefer. The driver can then select a preferred repair facility from the user interface, so that at block 326 the process listens for which repair facility the driver prefers and at block 328 it notifies the repair facility 128 selected by the driver so that the repair facility can know that the vehicle will be coming in for repair and that they need to order a replacement component. The process can also notify the component factory 130, so that a component can be shipped to the repair facility immediately if the repair facility doesn't have one in stock. The process ends at block 330.

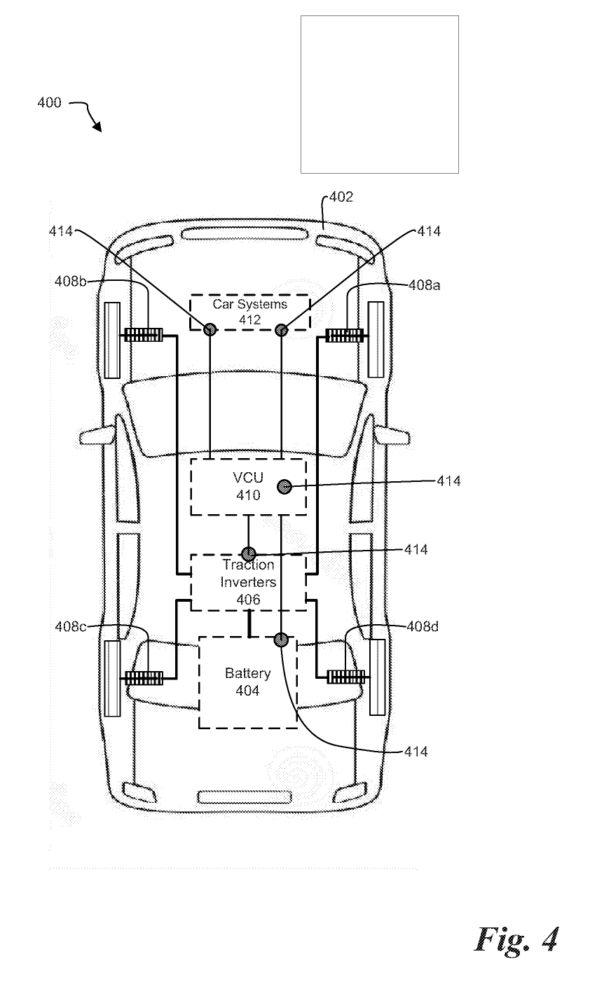

FIG. 4 illustrates an embodiment of a vehicle 400 that includes an onboard reporting system such as system 102 shown in block-diagram form in FIG. 1. In the illustrated embodiment vehicle 400 is an electric passenger car, but in other embodiments it can be other another type of electric vehicle such as a truck. In still other embodiments, it can be a partially electric (i.e., hybrid) vehicle or a non-electric vehicle such as a vehicle with a traditional internal combustion engine.

Vehicle 400 has a body 402 and a drivetrain with at least one electric motor coupled to the car's wheels. In the illustrated embodiment, electric motors 408a-408d are coupled to all four of the vehicle's wheels, but in other embodiments not all the car's wheels need have a corresponding electric motor. Electric motors 408a-408d are coupled to battery 404 via traction inverters 406. Traction inverters 406 are used to condition electrical energy and direct it to the appropriate components in the car. When the vehicle is running, for instance, the traction inverters can convert direct current from battery 404 into alternating current or vice versa to electric motors 408a-408d.

Vehicle 400 also includes car systems 412 which can include cooling for the car's systems such as electric motors 210a-210d, air conditioning for the vehicle cabin, gas engine control electronics (in a hybrid or internal-combustion embodiment) and other electronic components or accessories on the inside or outside of the car.

A vehicle control unit (VCU) 410 is also positioned in vehicle 400. VCU 410 is communicatively coupled, via electronic control units (ECUs) within each component (not shown in FIG. 4, but see FIG. 1), to sensors 414 positioned in the various systems—battery 404, traction inverters 406 and car systems 412. VCU 410 can include a sensor 414 within itself, so that it can self-monitor. As in system 100, sensors 414 can be direct sensors that measure a lifetime determinant or proxy sensors that measure a proxy lifetime determinant, and sensors 414 need not be the same type of sensor in every system or component to which they are coupled. Although not shown in FIG. 4, the other components within vehicle 102 (see FIG. 1), such as VCU 106 (with an internal or external clock 108) a GPS unit, a user interface, a transceiver, and an antenna, through which vehicle 400 can wirelessly transmit data to, and receive data from, a cloud computing center—will also be present in vehicle 400. Operation of the components in vehicle 400 is as described above for FIGS. 1-3.

The described apparatus and process have several advantages. Current lifetime evaluation methods of components such as power semiconductor modules are based on predefined mission profiles. Therefore, these evaluation methods are offline and fail to provide the real-time SOH estimation of power semiconductor modules, and thus cannot be used for predictive maintenance. The described cloud-based predictive maintenance method can solve these issues through three steps. First, the real-time temperature data of components such as power modules in the traction inverter rather than the off-line temperatures obtained by predefined specified mission profiles is sent to the cloud. Second, the collected real-time long-term temperature data can be utilized in a lifetime model and then used to compute the SOH of power modules, which is done by the cloud resource instead of the local VCU. This saves execution time, computational resources, and cost. Finally, by using the SOH information of components such as power semiconductor modules, vehicles can send an EOL warning to the vehicle when the modules are approaching the end of their lifetime. Also, a vehicle repair facility can order the corresponding components for replacement preparation, thereby providing better service to customers. In addition to predictive maintenance, statistical information of the profiles collected in the cloud can be given to the power semiconductor supplier, thus helping the semiconductor supplier improve the reliability or refine their products to meet the customers' requirement.

The above description of embodiments, including what is described in the abstract, is not intended to be exhaustive or to limit the invention to the described forms. Specific embodiments of, and examples for, the invention are described herein for illustrative purposes, but various equivalent modifications are possible within the scope of the invention in light of the above detailed description, as those skilled in the relevant art will recognize.

What is claimed is:

1. An apparatus comprising:
a component positioned in a vehicle;
a direct sensor, a proxy sensor, or both, coupled to the component;
a controller communicatively coupled to the direct sensor, the proxy sensor, or both;
a transceiver communicatively coupled to the controller and to an antenna;
a user interface communicatively coupled to the controller;
wherein the controller includes instructions stored thereon that, when executed by the controller, cause the controller to:
sample a measurement of a lifetime determinant from the direct sensor, a measurement of a proxy lifetime determinant from the proxy sensor, or both, at a sampling frequency;
timestamp each sample of the lifetime determinant and the proxy lifetime determinant;
at the end of a reporting period, assemble a dataset including a vehicle identifier, a component identifier, the samples of at least one of the lifetime determinant or the proxy lifetime determinant, and the timestamp associated with each sample of the lifetime determinant or the proxy lifetime determinant; and
transmit the dataset to a cloud computing center via the transceiver and the antenna.

2. The apparatus of claim 1 wherein the instructions stored on the controller further comprise instructions that, when executed by the controller, cause the controller to:
receive an end-of-life warning for the component from the cloud computing center via the transceiver; and
display the end-of-life warning on the user interface.

3. The apparatus of claim 2 wherein the end-of-life warning indicates the remaining lifetime of the component.

4. The apparatus of claim 3 wherein the end-of-life warning indicates the location of a repair facility.

5. The apparatus of claim 4 wherein the repair facility is near the vehicle's home.

6. The apparatus of claim 1 wherein the dataset further includes the vehicle's current location.

7. The apparatus of claim 6 wherein the instructions stored on the controller further comprise instructions that, when executed by the controller, cause the controller to display a list of one or more repair facilities near the vehicle's current location.

8. The apparatus of claim 7 wherein the instructions stored on the controller further comprise instructions that, when executed by the controller, cause the controller to receive a user selection of a repair facility from the list of one or more repair facilities near the vehicle's current location.

9. The apparatus of claim 8 wherein the instructions stored on the controller further comprise instructions that, when executed by the controller, cause the controller to transmit the user selection to the cloud computing center via the transceiver.

10. An apparatus for cloud-based computing, the apparatus comprising:
a communication interface;
one or more databases;
a server coupled to the communication interface and to the one or more databases, wherein the server includes instructions stored thereon that, when executed by the server, cause the server to:
receive a dataset through the communication interface, the dataset including a vehicle identifier, a component identifier, samples of at least one of the lifetime determinant or the proxy lifetime determinant, and a timestamp associated with each sample of the lifetime determinant or the proxy lifetime determinant;
access the one or more databases to:
add the data from the received dataset to a stored time history of the lifetime determinant or the proxy lifetime determinant for the component identified in the received dataset and the vehicle associated with the vehicle identifier,
extract lifetime data for the component identified in the received dataset, and
based on the lifetime data, at least one of the lifetime determinant or the proxy lifetime determinant, and the time history of the lifetime determinant or the proxy lifetime determinant, compute a state-of-health that quantifies the remaining lifetime of the component;
if the state-of-health of the component falls within an imminence threshold, transmit a warning to the operator of the vehicle associated with the vehicle identifier.

11. The apparatus of claim 10 wherein the server further includes instructions stored thereon that, when executed by the server, cause the server to add the data from the dataset to a fleet database that aggregates the data of datasets received from multiple vehicles.

12. The apparatus of claim 11 wherein the lifetime data is based on life-cycle data from the fleet database.

13. The apparatus of claim 11 wherein the lifetime information is based on laboratory tests of the component.

14. The apparatus of claim 10 wherein the lifetime determinant is temperature T and the state-of-health (SOH) is calculated using the formula:
$$SOH = 1 - {\sum }_{i = 1}^{n} \frac{{N}_{i}}{{N}_{fi}}$$
where N_{fi} is the lifetime number of cycles measured at a temperature fluctuation of ΔTᵢ and Nᵢ is the accumulated number of cycles at the temperature fluctuation ΔTᵢ.

15. The apparatus of claim 10 wherein the server further includes instructions stored thereon that, when executed by the server, cause the server to notify a repair facility of the vehicle identifier and of the imminent failure of the component identified by the component identified in the dataset.

16. The apparatus of claim 15 wherein the repair facility notified is the one closest to the vehicle's home or is a repair facility previously identified by the vehicle's owner and stored in one of the one or more databases.

17. The apparatus of claim 15 wherein the dataset includes the vehicle's current location and the repair facility notified is the repair facility closest to the vehicle's current location.

18. A system for vehicle maintenance comprising:
a vehicle comprising:
a direct sensor, a proxy sensor, or both, coupled to a component in the vehicle;
a controller communicatively coupled to the direct sensor, the proxy sensor, or both;
a transceiver communicatively coupled to the controller and to an antenna;
a user interface communicatively coupled to the controller;
wherein the controller includes instructions stored thereon that, when executed by the controller, cause the controller to:
sample a measurement of a lifetime determinant from the direct sensor, a measurement of a proxy lifetime determinant from the proxy sensor, or both, at a sampling frequency;
timestamp each sample of the lifetime determinant and the proxy lifetime determinant;
at the end of a reporting period, assemble a dataset including a vehicle identifier, a component identifier, the samples of at least one of the lifetime determinant or the proxy lifetime determinant, and the timestamp associated with each sample of the lifetime determinant or the proxy lifetime determinant; and
transmit the dataset via the transceiver; and
a cloud computing center comprising:
a communication interface;
one or more databases;
a server coupled to the communication interface and to the one or more databases, wherein the server includes instructions stored thereon that, when executed by the server, cause the server to:
receive the dataset from the vehicle via the communication interface;
access the one or more databases to:
add the data from the received dataset to a stored time history of the lifetime determinant or the proxy lifetime determinant for the component identified in the received dataset and the vehicle associated with the vehicle identifier,
extract lifetime data for the component identified in the received dataset, and
based on the lifetime data, at least one of the lifetime determinant or the proxy lifetime determinant, and the time history of the lifetime determinant or the proxy lifetime determinant, compute a state-of-health that quantifies the remaining lifetime of the component; and
if the state-of-health of the component falls within an imminence threshold, transmit a warning to the operator of the vehicle associated with the vehicle identifier.

19. The system of claim 18 wherein the instructions stored on the controller further comprise instructions that, when executed by the controller, cause the controller to:
receive an end-of-life warning for the component from the cloud via the transceiver; and
display the end-of-life warning on the user interface.

20. The system of claim 19 wherein the end-of-life warning indicates the remaining lifetime of the component.

21. The system of claim 20 wherein the end-of-life warning indicates the location of a repair facility.

22. The system of claim 21 wherein the repair facility is near the vehicle's home or near the vehicle's current location.

23. The system of claim 18 wherein the dataset further includes the vehicle's current location.

24. The system of claim 23 wherein the instructions stored on the controller further comprise instructions that, when executed by the controller, cause the controller to display a list of one or more repair facilities near the vehicle's current location.

25. The system of claim 24 wherein the instructions stored on the controller further comprise instructions that, when executed by the controller, cause the controller to receive a user selection of a repair facility from the list of one or more repair facilities near the vehicle's current location.

26. The system of claim 25 wherein the instructions stored on the controller further comprise instructions that, when executed by the controller, cause the controller to transmit the user selection to the cloud via the transceiver.

27. The system of claim 18 wherein the server further includes instructions stored thereon that, when executed by the server, cause the server to add the data from the dataset to a fleet database that includes the data of datasets received from multiple vehicles.

28. The system of claim 27 wherein the lifetime data is based on life-cycle data from the fleet database.

29. The system of claim 18 wherein the lifetime information is based on laboratory tests of the component.

30. The system of claim 18 wherein the lifetime determinant is temperature T and the state-of-health (SOH) is calculated using the formula:
$$SOH = 1 - {\sum }_{i = 1}^{n} \frac{{N}_{i}}{{N}_{fi}}$$
where N_{fi} is the lifetime number of cycles measured at a temperature fluctuation of ΔTᵢ and Nᵢ is the accumulated number of cycles at the temperature fluctuation ΔTᵢ.

31. The system of claim 18 wherein the server further includes instructions stored thereon that, when executed by the server, cause the server to notify a repair facility of the vehicle identifier and the imminent failure of the component identified by the component identified in the dataset.

32. The system of claim 31 wherein the repair facility notified is the one closest to the vehicle's home or is a repair facility previously identified by the vehicle's owner and stored in the database.

33. The system of claim 31 wherein the dataset includes the vehicle's current location and the repair facility notified is the repair facility closest to the vehicle's current location.

34. A method comprising:
sampling, at a sampling frequency, a measurement of a lifetime determinant from a direct sensor, a measurement of a proxy lifetime determinant from a proxy sensor, or both, wherein the direct sensor and the proxy sensor are coupled to a component in a vehicle;
timestamping each sample of the lifetime determinant or the proxy lifetime determinant;
at the end of a reporting period, assembling a dataset including a vehicle identifier, a component identifier, the samples of at least one of the lifetime determinant or the proxy lifetime determinant, and the timestamp associated with each sample of the lifetime determinant or the proxy lifetime determinant; and
transmitting the dataset to a cloud computing center.

35. The method of claim 34, further comprising:
receiving an end-of-life warning for the component from the cloud computing center; and
displaying the end-of-life warning on a user interface in the vehicle.

36. The method of claim 35 wherein the end-of-life warning indicates the remaining lifetime of the component.

37. The method of claim 36 wherein the end-of-life warning indicates the location of a repair facility.

38. The method of claim 37 wherein the repair facility is near the vehicle's home or near the vehicle's current location.

39. The method of claim 34 wherein the dataset further includes the vehicle's current location.

40. The method of claim 39, further comprising displaying a list of one or more repair facilities near the vehicle's current location.

41. The method of claim 40, further comprising receiving a user selection of a repair facility from the list of one or more repair facilities near the vehicle's current location.

42. The method of claim 41, further comprising transmitting the user selection to the cloud computing center.

43. A method for cloud-based computing, the process comprising:
receiving a dataset from a vehicle, the vehicle including one or both of a direct sensor or a proxy sensor coupled to a component, the dataset including a vehicle identifier, a component identifier, samples of at least one of the lifetime determinant or the proxy lifetime determinant, and a timestamp associated with each sample of the lifetime determinant or the proxy lifetime determinant;
accessing one or more databases to:
add the data from the received dataset to a stored time history of the lifetime determinant or the proxy lifetime determinant for the component identified in the received dataset and the vehicle associated with the vehicle identifier,
extract lifetime data for the component identified in the received dataset, and
based on the lifetime data, at least one of the lifetime determinant or the proxy lifetime determinant, and a time history of the lifetime determinant or the proxy lifetime determinant, compute a state-of-health that quantifies the remaining lifetime of the component;
transmitting a warning to the operator of the vehicle associated with the vehicle identifier if the state-of-health of the component falls within an imminence threshold.

44. The method of claim 43, further comprising adding the data from the dataset to a fleet database that includes the data of datasets received from multiple vehicles.

45. The method of claim 44 wherein the lifetime data is based on life-cycle data from the fleet database.

46. The method of claim 44 wherein the lifetime information is based on laboratory tests of the component.

47. The method of claim 10 wherein the lifetime determinant is temperature T and the state-of-health (SOH) is calculated using the formula:
$$SOH = 1 - {\sum }_{i = 1}^{n} \frac{{N}_{i}}{{N}_{fi}}$$
where N_{fi} is the lifetime number of cycles measured at a temperature fluctuation of ΔTᵢ and Nᵢ is the accumulated number of cycles at the temperature fluctuation ΔTᵢ.

48. The method of claim 43, further comprising notifying a repair facility of the vehicle identifier and the imminent failure of the component identified by the component identified in the dataset.

49. The method of claim 48 wherein the repair facility notified is the one closest to the vehicle's home or is a repair facility previously identified by the vehicle's owner and stored in the database.

50. The method of claim 48 wherein the dataset includes the vehicle's current location and the repair facility notified is the repair facility closest to the vehicle's current location.
